(19) United States
(12) Patent Application Publication
(10) Pub. No.: US 2008/0222404 A1
(43) Pub. Date: Sep. 11, 2008

(54) In-system programming system and method for motherboard

(75) Inventors: Xiao Jiang, Tianjin (CN); Quan-Jie Zheng, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/708,488

(22) Filed: Feb. 21, 2007

(51) Int. Cl. G06F 9/00

(52) U.S. Cl. 713/1

(57) ABSTRACT

An in-system programming system and method is provided, which is applicable for chip programming of a computer motherboard. Firstly, a programming interface is configured in the computer motherboard, in which one end of the programming interface is connected to an on-board programmer, and the other end is connected to a plurality of chips to be programmed, thereby achieving the communication between the on-board programmer and the chips. Next, a motherboard connector and the programming interface are connected, and the motherboard connector and the on-board programmer are communicated through a communication interface of the on-board programmer. Then, the other end of the motherboard connector is connected to a programmable master-control program. Then, when the programmable master-control program is used for programming, programming contents of the programmable master-control program are transmitted to the on-board programmer through the communication between the motherboard connector and the on-board programmer, so as to program the chip.

### BACKGROUND OF THE INVENTION

1. Field of Invention

The present invention relates to a programming system of a server motherboard, and more particularly to an in-system programming system of a motherboard and an implementation method therefor.

2. Related Art

Generally, many devices on a server motherboard are required to be correspondingly configured or programmed before leaving factories. The devices are mainly classified into storage units and controllers, in which the storage unit includes, for example, an electrically erasable programmable read-only memory (EEPROM), a flash, and the like, and the controller includes, for example, a peripheral interface controller (PIC) single-chip computer, a system on programmable chip (SOPC) single-chip computer, and the like. The bus interfaces of the devices are quite different in types and they are difficult to be configured or programmed.

There are two schemes for programming the devices on the motherboard. One scheme is called off-line programming, i.e., configuring or programming a chip first, and then soldering the chip onto the motherboard; and the other scheme is called in-system programming, i.e., soldering a chip onto the motherboard first, and then configuring or programming the chip. Currently, the in-system programming is most popularly applied in a stage of designing the motherboard, and certain pins are reserved in advance to serve as programming pins, and they are exposed outside in the form of pin headers to serve as a connection interface between a burner and the motherboard. After being soldered, the motherboard is programmed by a tool provided by a manufacturer or by a programmer self-designed by an assembly line.

However, the in-system programming method in the prior art still has the following defects. 1. If the chip is a flash with a parallel interface, a lot of pin headers are required to be exposed outside, which thus causing a difficult in the wiring of the motherboard, so that the in-system programming is not suitable for the current flash. 2. The reserved pins become useless once the server leaves the factory, which not only wastes the space of the motherboard, but also enables a user to change the contents of the chip of the motherboard, and if the contents of the chip can be read and modified through the reserved pins, the motherboard is unstable. 3. The programmer is far away from a target programmable chip, which increases the distance for signal transmission, thereby affecting signal intensity and accuracy of the transmission. Especially, the increasing of the circuit length causes signal crosstalk, which thus degrades the anti-interference capability of a signal. Furthermore, an introduced in-system resistor degrades the stability of the signal, which greatly influences the accuracy of the burned result. 4. The chips to be programmed are distributed on the motherboard in a scattered manner, and in the course of programming, the circuits of the programmer are respectively connected to corresponding target chips depending upon functions, so the efficiency is low and mistakes often occur, and thereby missing contents. 5. The programmer cannot be applicable for all the chips to be programmed on the motherboard, and more programming tools are required to program the chips, so the operation is complicated and time-consuming.

### SUMMARY OF THE INVENTION

In order to solve the problems and defects in the aforementioned prior art, the present invention is directed to an in-system programming system and method for a motherboard, which not only achieves the simple and convenient programming of the motherboard, but also ensures the safety and stability of the motherboard.

Therefore, the present invention provides an in-system programming system for a motherboard, which is applicable for a computer motherboard and includes a programming interface connector and a motherboard connector. Herein, the programming interface connector is disposed on the computer motherboard. One end of the programming interface connector is connected to an on-board programmer, and the other end is connected to a plurality of chips to be programmed, thereby achieving the communication between the on-board programmer and the chips to be programmed. One end of the motherboard connector is connected to a programmable master-control program through a computer connector, and the other end is connected to the programming interface connector. The on-board programmer and the programmable master-control program are communicated with each other through a communication interface of the on-board programmer, thereby transmitting the programming contents of the programmable master-control program to the on-board programmer for programming the corresponding chips to be programmed.

The in-system programming system for the motherboard of the present invention further includes a bus switch disposed between the motherboard connector and the programming interface connector, so as to connect or disconnect the communication therebetween. Preferably, the on-board programmer is replaceable. Furthermore, the system includes a multi-way switch disposed between the programming interface connector and the chips to be programmed, so as to switch the communication buses between the on-board connector and the chips to be programmed according to the types of the programming interfaces of the chips to be programmed.

Moreover, the present invention further provides an in-system programming method for a motherboard, applicable for the chip programming of the computer motherboard, which includes: configuring a programming interface—in the computer motherboard, in which one end of the programming interface is connected to an on-board programmer, and the other end is connected to a plurality of chips to be programmed, so as to achieve the communication between the on-board programmer and the chips to be programmed; connecting a motherboard connector to the programming interface, and achieving the communication between the-motherboard connector and the on-board programmer through a communication interface of the on-board programmer; connecting the other end of the motherboard connector to a programmable master-control program; and when the programmable master-control program is used for programming, transmitting the programming contents of the programmable master-control program to the on-board programmer through the communication between the motherboard connector and the on-board programmer, so as to program the corresponding chips to be programmed.

The process for the programmable master-control program to program the chips to be programmed further includes: the programmable master-control program transmits a control command to the on-board programmer and configures input/output ports, so as to inform the on-board programmer about the types of the chips to be programmed; the programmable master-control program sends a start programming command to the on-board programmer, and sends data fragments of the chips to be programmed; and the on-board programmer receives and transmits the data fragments to the corresponding chips to be programmed.

In the present invention, through disposing the on-board programmer on the motherboard, i.e., the motherboard is connected to the on-board programmer through wiring when being designed, the type, quantity, and bus interface of the chips to be burned are determined. Then, a programming interface is provided for the chips to be programmed through the on-board programmer, thereby avoiding the problem that the distance between the on-board programmer and the buses of the devices on the motherboard is excessively long, and thus reducing the unstable factors of the buses caused by the distance of the buses, and thus achieving the in-system programming of the chip with more pins.

Furthermore, through the aforementioned configuration, programming staff and users cannot face the reserved programming pins directly, which thus protects the contents in the devices on the motherboard and enhances the safety and stability of the motherboard.

The present invention controls the in-system programming of the chips to be programmed through connecting the programmer to the programming interface connector, and utilizing the communication between an original universal serial bus (USB) interface on the motherboard and a computer programming software. Therefore, with regard to a movably-connected programmer, the programmer can be used repeatedly, thereby reducing the manufacturing cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a block diagram of an in-system programming system for a motherboard according to the present invention;

FIG. 2 is a block diagram of a programming switching system of the in-system programming system for the motherboard according to the present invention; and

FIG. 3 is a flow chart of steps of an in-system programming method for a motherboard according to the present invention.

### DETAILED DESCRIPTION OF THE INVENTION

The features and practice of the preferred embodiments of the present invention will be illustrated below in detail with reference to the drawings.

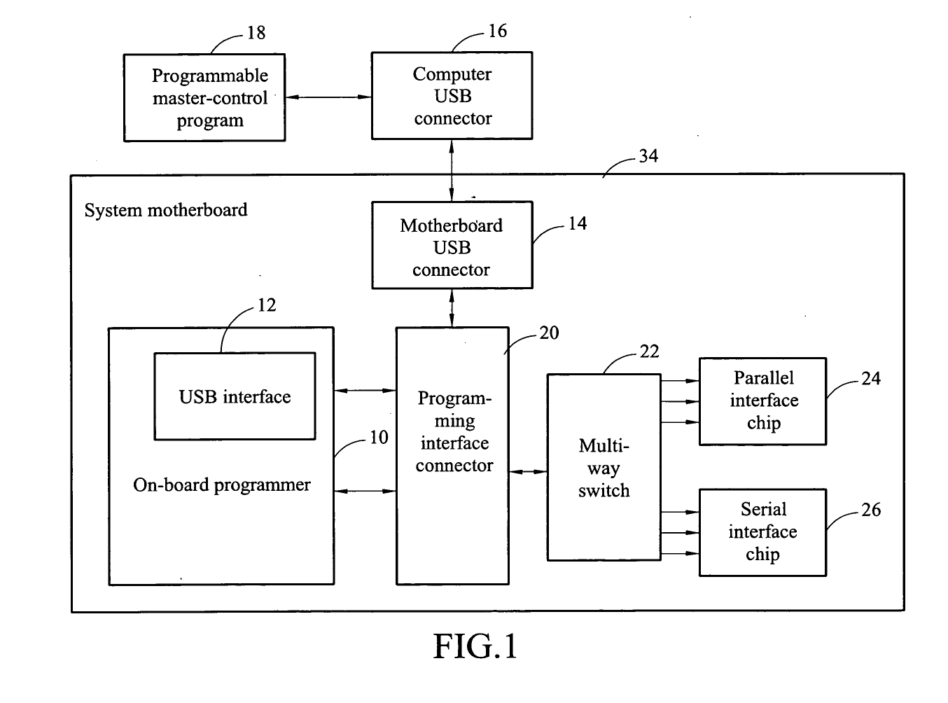

Referring to FIG. 1, it is a block diagram of an in-system programming system for a motherboard according to the present invention.

As shown in FIG. 1, the in-system programming system for a motherboard includes a programming interface connector 20 disposed on a system motherboard 34. Reserved programming pins are directly connected to the programming interface connector 20, and exposed outside the programming interface connector 20. One end of the programming interface connector 20 is connected to a plurality of chips to be programmed through pins hidden in the system motherboard 34, such as an electrically erasable programmable read-only memory (EEPROM), a flash, and a peripheral interface controller (PIC). Furthermore, the other end of the programming interface connector 20 is connected to an on-board programmer 10 through the exposed pins of the programming interface connector 20. The on-board programmer 10 is connected to the programming interface connector 20 in a fixed or detachable way, so as to program a target chip on the system motherboard 34. Preferably, the on-board programmer 10 is replaceable, that is, which can be taken off from the programming interface connector 20 once the chip programming is finished, so as to program other motherboards, thereby significantly reducing hardware cost, and supporting a chip to be programmed with a new bus type by means of updating a software base according to different contents of the chips on the motherboard.

Moreover, the programming interface connector 20 is further connected to a motherboard USB connector 14. The other end of motherboard USB connector 14 is connected to a programmable master-control program 18 through a computer USB connector 16. The programmable master-control program 18 may be a programming software running in a computer device, or a programming device. The motherboard USB connector 14 is further connected to the communication interface of the on-board programmer 10 through the programming interface connector 20, such as a USB interface 12, and then, the programmable master-control program 18 transmits the programming contents to the on-board programmer 10 through the communication between the motherboard USB connector 14 and the USB interface 12, and finishes the programming operation of a motherboard chip together with the on-board programmer 10.

With reference to FIG. 1, the chip programming principle of the motherboard by using the in-system programming system for the motherboard of the present invention is illustrated below in detail.

The on-board programmer 10 receives the data from the programmable master-control program 18, and transmits the programming contents to the target chip, such as a parallel interface chip 24 or a serial interface chip 26, through the programming interface connector 20. A multi-way switch 22 is connected between the programming interface connector 20 and the chips to be programmed, which is used for switching the bus switch of the target chip, so as to cater to the chips on the system motherboard 34 with different types of buses and support various kinds of chip programming when the type of the programming interface is parallel and serial. The multi-way switch 22 is also replaceable, which can be taken off when the programming is finished, and thus, not only reducing the cost, but also reducing the possible signal interference.

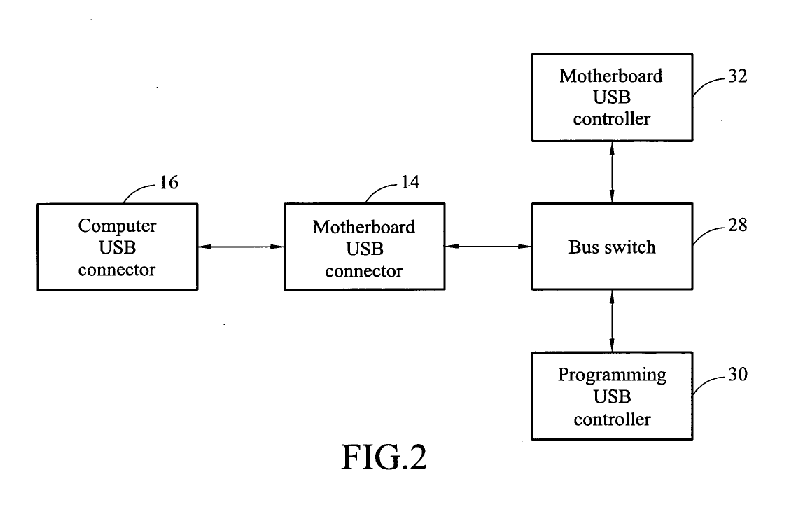

Referring to FIG. 2, it is a block diagram of a programming switching system of the in-system programming system for a motherboard according to the present invention, which mainly illustrates the principle for the bus switch 28 to switch between the programming USB controller 30 and the motherboard USB controller 32.

As shown in FIG. 2, the bus switch 28 is disposed between the motherboard USB connector 14 and the above two controllers 30 and 32. When the on-board programmer 10 is not inserted, the motherboard USB connector 14 is always controlled by the motherboard USB controller 32, i.e., the motherboard USB connector 14 and the motherboard USB controller 32 are normally connected, so as to achieve the normal functions of the USB of the system motherboard 34. However, when the on-board programmer 10 is inserted into the programming interface connector 20, the bus switch 28 disconnects the connecting circuit between the motherboard USB connector 14 and the motherboard USB controller 32, and connects the motherboard USB connector 14 to the programming USB controller 30, so as to take over the accessing right of the motherboard USB connector 14, and thereby achieving the communication between the on-board programmer 10 and the programming interface connector 20. If the on-board programmer 10 is removed after the programming is finished, the connection between the motherboard USB connector 14 and the corresponding controller is restored through the switching of the bus switch 28, without influencing the functions of the motherboard USB.

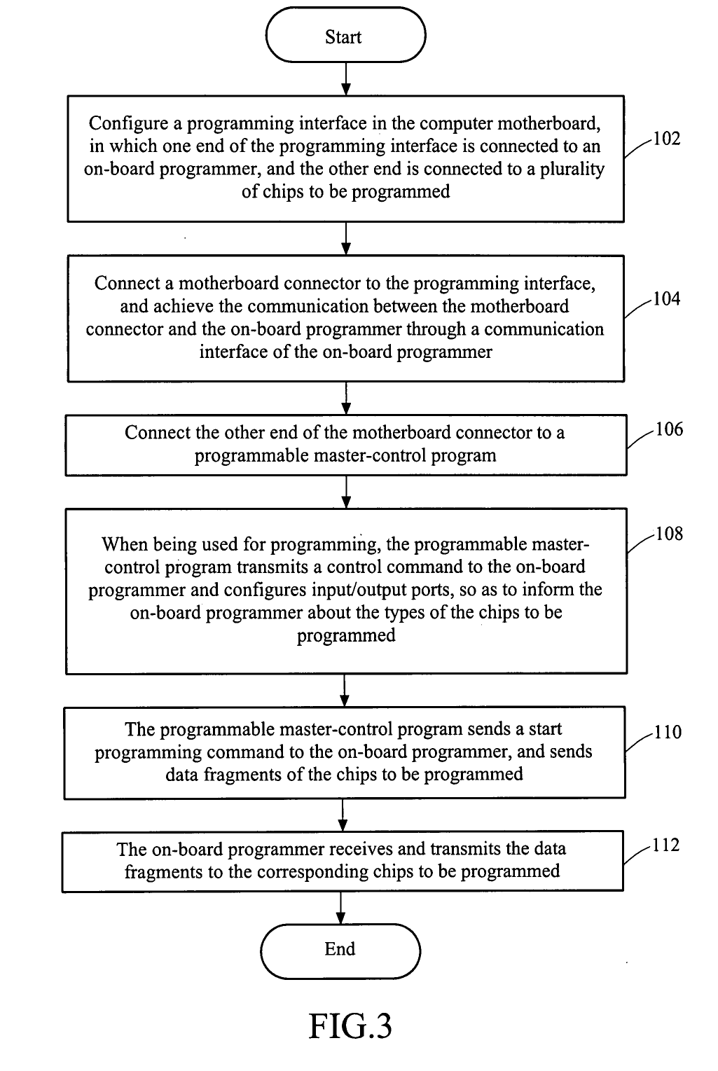

Referring to FIG. 3, it is a flow chart of steps of an in-system programming method for a motherboard according to the present invention.

As shown in FIG. 3, firstly, a programming interface is configured on the computer motherboard. One end of the programming interface is connected to an on-board programmer, and the other end is connected to a plurality of chips to be programmed (Step 102). The on-board programmer may be designed to be only applicable for a single-model motherboard, or applicable for supporting various types of motherboards, and designed as a part of the motherboard. The on-board programmer may be movably disposed or soldered to the motherboard, and in order to reduce the manufacturing cost, preferably, the on-board programmer is movably connected to the programming interface of the motherboard, i.e., the on-board programmer is replaceable.

Afterwards, a motherboard connector is connected to the programming interface, and the communication between the motherboard connector and the on-board programmer is achieved through the communication interface of the on-board programmer (Step 104). When the on-board programmer is connected to the programming interface, the motherboard connector and the programming interface are also connected, thereby achieving the communication between the motherboard connector and the on-board programmer. When the on-board programmer is not connected to the programming interface, the communication between the motherboard connector and the programming interface is disconnected, such that the motherboard connector may run normally, and controlled by the corresponding controller on the motherboard.

Next, the other end of the motherboard connector is further connected to a programmable master-control program (Step 106). The programmable master-control program is mainly used to perform in-system programming on the chips to be programmed of the motherboard, which may be a programming software installed in the computer device or a programming device. Through the aforementioned steps, the communication between the on-board programmer and the programmable master-control program is achieved by the motherboard connector, so as to transmit the programming contents to the on-board programmer, and thereby achieving the in-system programming of the target chip on the motherboard.

The programming process includes the following steps. The programmable master-control program firstly transmits a control command through, for example, the USB, and configures input/output ports, so as to inform the on-board programmer about the types of the chips connected to each of the input/output ports (Step 108). Then, the programmable master-control program actively begins the programming operation for one of the chips, i.e., sends the control command to the on-board programmer, and then sends data fragments of the chip to the on-board programmer (Step 110). Then, the on-board programmer transmits the received data fragments to the corresponding target chip for being programmed (Step 112). The programmable master-control program may determine whether the previous chip has been programmed or not, and if the chip has already been programmed, the next chip is programmed; otherwise, the data fragments of the current chip are continuously sent out.

Additionally, according to the in-system programming method for a motherboard of the present invention, as for the chips to be programmed with different bus types, such as parallel and serial chips, the bus switch of the target chip may be switched, which is thus applicable for the chips with different bus types on the system motherboard 34, and thereby supporting various kinds of chip programming.

In the present invention, through disposing the on-board programmer on the motherboard, i.e., the motherboard is connected to the on-board programmer through wiring when being designed, the type, quantity, and bus interface of the chips to be burned are determined. Then, a programming interface is provided for the chips to be programmed through the on-board programmer, thereby avoiding the problem that the distance between the on-board programmer and the buses of the devices on the motherboard is excessively long, and thus reducing the unstable factors of the buses caused by the distance of the buses, and thus achieving the in-system programming of the chip with more pins. Furthermore, the programming interface may be masked through the above configuration, thereby protecting the components of the devices on the motherboard and enhancing the safety and stability of the motherboard.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An in-system programming system for a motherboard, applicable for a computer motherboard, comprising:
a programming interface connector, disposed on the computer motherboard, wherein one end of the programming interface connector is connected to an on-board programmer, and other end is connected to a plurality of chips to be programmed, so as to achieve a communication between the on-board programmer and the chips to be programmed; and
a motherboard connector, having one end being connected to a programmable master-control program through a computer connector, and having other end being connected to the programming interface connector, wherein the on-board programmer and the programmable master-control program are communicated with each other through a communication interface of the on-board programmer, thereby transmitting programming contents of the programmable master-control program to the on-board programmer to program the corresponding chips to be programmed.

2. The in-system programming system for the motherboard as claimed in claim 1, wherein the system further comprises a multi-way switch connected between the programming interface connector and the chips to be programmed, so as to switch a communication bus between the on-board connector and the chips to be programmed according to types of the programming interfaces of the chips to be programmed.

3. The in-system programming system for the motherboard as claimed in claim 1, wherein the system further comprises a bus switch connected between the motherboard connector and the programming interface connector to switch on or off a communication between the motherboard connector and the programming interface connector.

4. The in-system programming system for the motherboard as claimed in claim 3, wherein when the on-board programmer is connected to the programming interface connector, the bus switch switches on the communication between the motherboard connector and the programming interface connector.

5. The in-system programming system for the motherboard as claimed in claim 3, wherein when a connection between the on-board programmer and the programming interface connector is cut off, the bus switch switches off the communication between the motherboard connector and the programming interface connector.

6. The in-system programming system for the motherboard as claimed in claim 5, wherein the on-board programmer is replaceable, and movably connected to the programming interface connector.

7. An in-system programming method for a motherboard, applicable for a chip programming of a computer motherboard, comprising:
configuring a programming interface in the computer motherboard, wherein one end of the programming interface is connected to an on-board programmer, and other end is connected to a plurality of chips to be programmed, so as to achieve a communication between the on-board programmer and the chips to be programmed;
connecting a motherboard connector to the programming interface, wherein a communication between the motherboard connector and the on-board programmer is achieved through a communication interface of the on-board programmer;
connecting other end of the motherboard connector to a programmable master-control program; and
transmitting programming contents of the programmable master-control program to the on-board programmer through the communication between the motherboard connector and the on-board programmer when the programmable master-control program is used for programming, so as to program the corresponding chips to be programmed.

8. The in-system programming method for the motherboard as claimed in claim 7, wherein the step of programming the chips to be programmed through the programmable master-control program further comprises:
transmitting a control command to the on-board programmer and configuring input/output ports by the programmable master-control program, so as to inform the on-board programmer about types of the chips to be programmed;
sending a start programming command to the on-board programmer by the programmable master-control program, and sending data fragments of the chips to be programmed; and
receiving and transmitting the data fragments by the on-board programmer to the corresponding chips to be programmed.

9. The in-system programming method for the motherboard as claimed in claim 8, further comprising a step of switching communication buses of the on-board connector and the chips to be programmed according to the types of the chips to be programmed.

10. The in-system programming method for the motherboard as claimed in claim 7, wherein the on-board programmer is replaceable, and movably connected to the programming interface.

11. The in-system programming method for the motherboard as claimed in claim 10, wherein the on-board programmer is not connected to the programming interface, a communication between the motherboard connector and the programming interface is cut off.
